(19) United States
(12) Patent Application Publication
(10) Pub. No.: US 2008/0095228 A1
(43) Pub. Date: Apr. 24, 2008

(54) SYSTEM AND METHOD FOR PROVIDING PICTURE OUTPUT INDICATIONS IN VIDEO CODING

(75) Inventors: Miska Hannuksela, Ruutana (FI); Ye-Kui Wang, Tampere (FI)

Correspondence Address: FOLEY & LARDNER LLP, P.O. BOX 80278, SAN DIEGO, CA, 92138-0278, US

(73) Assignee: Nokia Corporation

(21) Appl. No.: 11/736,454

(22) Filed: Apr. 17, 2007

Related U.S. Application Data
(60) Provisional application No. 60/853,215, filed on Oct. 20, 2006.

(51) Int. Cl. H04N 11/04

(52) U.S. Cl. 375/240.01; 375/E07.001

(57) ABSTRACT

An explicit signaling element for controlling decoded picture output and applications when picture output is not desired. A signal element, such as a syntax element in a coded video bitstream, is used to indicate (1) whether a certain decoded picture is output; (2) whether a certain set of pictures are output, wherein the set of pictures may be explicitly signaled or implicitly derived; or (3) whether a certain portion of a picture is output. The signal element may be a part of the coded picture or access unit that it is associated with, or it may reside in a separate syntax structure from the coded picture or access unit, such as a sequence parameter set. The signal element can be used both by an encoder and a decoder in a video coding system, as well as a processing unit that produces a subset of a bitstream as output.

### CROSS-REFERENCE TO RELATED APPLICATIONS

The present invention claims priority to U.S. Provisional Patent Application No. 60/853,215, filed Oct. 20, 2006.

### FIELD OF THE INVENTION

The present invention relates to video coding. More particularly, the present invention relates to the use of decoded pictures for purposes other than outputting.

### BACKGROUND OF THE INVENTION

This section is intended to provide a background or context to the invention that is recited in the claims. The description herein may include concepts that could be pursued, but are not necessarily ones that have been previously conceived or pursued. Therefore, unless otherwise indicated herein, what is described in this section is not prior art to the description and claims in this application and is not admitted to be prior art by inclusion in this section.

Video coding standards include ITU-T H.261, ISO/IEC MPEG-1 Visual, ITU-T H.262 or ISO/IEC MPEG-2 Visual, ITU-T H.263, ISO/IEC MPEG-4 Visual and ITU-T H.264 (also know as ISO/IEC MPEG-4 AVC). In addition, there are currently efforts underway with regards to the development of new video coding standards. One such standard under development is the scalable video coding (SVC) standard, which will become the scalable extension to H.264/AVC. Another standard under development is the multivideo coding standard (MVC), which is also an extension of H.264/AVC. Yet another such effort involves the development of China video coding standards.

A draft of the SVC is described in JVT-T201, “Joint Draft 7 of SVC Amendment,” 20th JVT Meeting, Klagenfurt, Austria, July 2006, available from http://ftp3.itu.ch/av-arch/jvt-site/2006_{—}07_Klagenfurt/JVT-T201.zip. A draft of MVC is in described in JVT-T208, “Joint Multiview Video Model (JMVM) 1.0”, 20th JVT meeting, Klagenfurt, Austria, July 2006, available from http://ftp3.itu.ch/av-arch/jvt-site/2006_{—}07_Klagenfurt/JVT-T208.zip. Both of these documents are incorporated herein by reference in their entireties.

In scalable video coding (SVC), a video signal can be encoded into a base layer and one or more enhancement layers constructed in a pyramidal fashion. An enhancement layer enhances the temporal resolution (i.e., the frame rate), the spatial resolution, or the quality of the video content represented by another layer or a portion of another layer. Each layer, together with its dependent layers, is one representation of the video signal at a certain spatial resolution, temporal resolution and quality level. A scalable layer together with its dependent layers are referred to as a “scalable layer representation.” The portion of a scalable bitstream corresponding to a scalable layer representation can be extracted and decoded to produce a representation of the original signal at certain fidelity.

In some cases, data in an enhancement layer can be truncated after a certain location, or at arbitrary positions, where each truncation position may include additional data representing increasingly enhanced visual quality. Such scalability is referred to as fine-grained (granularity) scalability (FGS). In contrast to FGS, the scalability provided by those enhancement layers that cannot be truncated is referred to as coarse-grained (granularity) scalability (CGS). CGS collectively includes traditional quality (SNR) scalability and spatial scalability.

The Joint Video Team (JVT) has been in the process of developing a SVC standard as an extension to the H.264/Advanced Video Coding (AVC) standard. SVC uses the same mechanism as H.264/AVC to provide temporal scalability. In AVC, the signaling of temporal scalability information is realized by using sub-sequence-related supplemental enhancement information (SEI) messages.

SVC uses an inter-layer prediction mechanism, wherein certain information can be predicted from layers other than the currently reconstructed layer or the next lower layer. Information that can be inter-layer predicted include intra texture, motion and residual data. Inter-layer motion prediction includes the prediction of block coding mode, header information, etc., wherein motion information from the lower layer may be used for prediction of the higher layer. In the case of intra coding, a prediction from surrounding macroblocks or from co-located macroblocks of lower layers is possible. These prediction techniques do not employ motion information and hence, are referred to as intra prediction techniques. Furthermore, residual data from lower layers can also be employed for prediction of the current layer.

The elementary unit for the output of an SVC encoder and the input of a SVC decoder is a Network Abstraction Layer (NAL) unit. A series of NAL units generated by an encoder is referred to as a NAL unit stream. For transport over packet-oriented networks or storage into structured files, NAL units are typically encapsulated into packets or similar structures. In the transmission or storage environments that do not provide framing structures, a bytestream format, which is similar to a start code-based bitstream structure, has been specified in Annex B of the H.264/AVC standard. The bytestream format separates NAL units from each other by attaching a start code in front of each NAL unit.

A Supplemental Enhancement Information (SEI) NAL unit contains one or more SEI messages, which are not required for the decoding of output pictures but assist in related processes, such as picture output timing, rendering, error detection, error concealment, and resource reservation. About 20 SEI messages are specified in the H.264/AVC standard and others are specified in SVC. The user data SEI messages enable organizations and companies to specify SEI messages for their own use. H.264/AVC and SVC contain the syntax and semantics for the specified SEI messages, but no process for handling the messages in the recipient is defined. Consequently, encoders are required to follow the H.264/AVC or SVC standard when they create SEI messages, and decoders conforming to the H.264/AVC or SVC standard are not required to process SEI messages for output order conformance. One of the reasons to include the syntax and semantics of SEI messages in H.264/AVC and SVC is to allow system specifications, such as Digital Video Broadcasting specifications, to interpret the supplemental information identically and hence interoperate. It is intended that system specifications can require the use of particular SEI messages both in the encoding end and in the decoding end, and the process for handling SEI messages in the recipient may be specified for the application in a system specification.

In H.264/AVC and SVC, coding parameters that remain unchanged through a coded video sequence are included in a sequence parameter set. In addition to parameters that are essential to the decoding process, the sequence parameter set may optionally contain video usability information (VUI), which includes parameters that are important for buffering, picture output timing, rendering, and resource reservation. There are two structures specified to carry sequence parameter sets—the sequence parameter set NAL unit containing all of the data for H.264/AVC pictures in the sequence, and the sequence parameter set extension for SVC. A picture parameter set contains such parameters that are likely to be unchanged in several coded pictures. Frequently changing picture-level data is repeated in each slice header, and picture parameter sets carry the remaining picture-level parameters. H.264/AVC syntax allows many instances of sequence and picture parameter sets, and each instance is identified with a unique identifier. Each slice header includes the identifier of the picture parameter set that is active for the decoding of the picture that contains the slice, and each picture parameter set contains the identifier of the active sequence parameter set. Consequently, the transmission of picture and sequence parameter sets does not have to be accurately synchronized with the transmission of slices. Instead, it is sufficient that the active sequence and picture parameter sets be received at any moment before they are referenced, which allows for transmission of parameter sets using a more reliable transmission mechanism compared to the protocols used for the slice data. For example, parameter sets can be included as a MIME parameter in the session description for H.264/AVC Real-Time Protocol (RTP) sessions. It is recommended to use an out-of-band reliable transmission mechanism whenever it is possible in the application in use. If parameter sets are transmitted in-band, they can be repeated to improve error robustness.

In multi-view video coding, video sequences output from different cameras, each corresponding to different views, are encoded into one bit-stream. After decoding, to display a certain view, the decoded pictures belong to that view are reconstructed and displayed. It is also possible that more than one view is reconstructed and displayed. Multi-view video coding has a wide variety of applications, including free-viewpoint video/television, 3D TV and surveillance.

In H.264/AVC, SVC or MVC, NAL units containing coded slices or slice data partitions are referred to as Video Coding Layer (VCL) NAL units. Other NAL units are non-VCL NAL units. All NAL units pertaining to a certain time form an access unit.

Overlay coding is based on independent coding of source sequences of a scene transition and run-time composition of the fade. In overlay coding, reconstructed pictures from two scenes, referred to herein as component images, are stored in a multi-picture buffer to enable efficient motion compensation during the transition. A cross-faded scene transition is composed from component pictures for display purposes only. Overlapping component images are overlaid so that the top picture is partially transparent. The bottom picture is referred to as the source picture. The cross-fade is defined as a filter operation between a source picture and the top picture.

There are a number of applications or use cases require the decoding a coded reference picture and storage of the resulting decoded reference picture but, at the same time, it is desirable to prevent the decoded picture from being output or displayed. One such situation involves the coding of a scalable bitstream, in which the base layer is used for the prediction of a quality refinement enhancement layer and a spatial refinement enhancement layer. In this case, the base layer does not represent the original uncompressed picture to a sufficient quality to be displayed. The quality refinement enhancement layer is not predicted from the spatial refinement enhancement layer or vice versa. Depending on the decoder's capabilities, only the base layer and the quality refinement enhancement layer, or the base layer and the spatial refinement enhancement layer may be provided for decoding. In this case, it is not beneficial to provide both the quality refinement enhancement layer and the spatial refinement enhancement layer for decoding. Signaling an indication that the base layer is not coded sufficiently to be displayed would prevent the decoder from decoding only the base layer, as well as prevent media-aware network elements (MANEs) from pruning the forwarded bitstream so as to contain only the base layer.

In another situation where the decoding and storage of a coded picture as a reference picture may be desirable, while preventing the decoded picture from being output or displayed involves a case of multiple enhancement layers, In this case, it is helpful to envision two enhancement layers A and B, where A relies on the base layer and B relies on A. Layer A or B may be a quality enhancement layer or spatial enhancement layer. The quality of base layer is not sufficiently high to be displayed, and both layers A and B can provide acceptable display quality. It is therefore ideal to switch between layers A and B when needed, e.g. subject to network connection bandwidth changes. Similarly as in above, a signaling indicating that the base layer is not coded sufficiently to be displayed would prevent decoders from decoding only the base layer and media-aware network elements (MANEs) from pruning the forwarded bitstream to contain the base layer only.

A third such situation involves the synthesizing of an output picture in a decoder based on pictures that are not output. One example involves overlay coding, which has been proposed for the coding of gradual scene transitions. Another example involves the insertion of a broadcaster's logo. In such cases, the television program or similar content is coded independently from the logo. The logo is coded as an independent picture with associated transparency information (e.g., an alpha plane). The broadcaster wants to mandate displaying of the logo. Therefore, the blending of the logo over pictures of the “main” content is a normative part of the video decoding standard. Only the blended pictures are output while it would be desirable that the pictures of the “main” content and for the logo picture themselves to be marked as not being output.

Currently the concept of indicating that pictures should be decoded but not output has been limited to specific use cases. In one such case, freeze picture commands specified as SEI messages of H.263 and H.264/AVC are used. These SEI messages instruct the display process of the decoding device. These SEI messages do not impact the output of the decoder itself. The full-picture freeze request function indicates that the contents of the entire prior displayed video picture should be kept unchanged until notified otherwise by a full-picture freeze release request or a timeout occurs. The partial-picture freeze request is similar to the full-picture request but concerns only an indicated rectangular area of the pictures.

In another such use case, a background picture is maintained and updated. The background picture can be used as a prediction reference, but it is never output. When a first INTRA frame or a scene change frame appears, the whole background picture is flashed with that frame. The background picture is updated block by block, if a block has a zero motion vector and coded with a finer quantization than the corresponding block in the background picture.

Another situation where such an indication is provided involves the use of a no_output_of_prior_pics_flag in the H.264/AVC standard. This flag is present in Instantaneous Decoding Refresh (IDR) pictures. When set to 1, the pictures prior to the IDR picture in decoding order and residing in the decoded picture buffer at the time of the decoding of IDR picture are not output.

Still another situation where such an indication is provided involves the use of a layer_base_flag of the SVC standard. This flag is used to indicate that a picture is decoded and stored as a base representation of a FGS picture and is used as inter prediction reference for a later FGS picture. A decoded base representation is not output unless there are no FGS enhancement pictures received. In earlier versions of SVC, a key_pic_flag equal to 1 and quality_level greater than 0 were used to indicate that the picture is decoded and stored as base representation and that the previous base representation is used as prediction reference for this picture.

Lastly, there are specific use cases where a picture is not output if a corresponding overlay picture is received. Overlay coding is based on independent coding of the source sequences of the scene transition and run-time composition of the fade. A picture of a first scene is decoded but not output if an overlay picture of the same time instant is received. The overlay picture contains the coded representation of a picture in the second scene and parameters for the composition of an indicated operation between the decoded pictures of the first scene and the second scene. The decoder performs the operation and outputs only the resulting picture of the operation, while the picture of the first scene and the picture of the second scene remain in the decoded picture buffer as inter prediction references. This system is described in detail in U.S. Patent Publication No. 2003/0142751, filed Jan. 22, 2003 and incorporated herein by reference in its entirety.

### SUMMARY OF THE INVENTION

The present invention provides for the use of one or more signaling elements, such as syntax elements, in a scalably coded video bitstream. In various embodiments of the present invention, one or more signal elements, such as syntax elements in a coded video bitstream, are used to indicate (1) whether a certain decoded picture is valid and/or otherwise desirable for output when the corresponding coded picture is intended to be used in association with another coded picture in producing another decoded picture; (2) whether a certain set of pictures, such as a scalable layer, are valid and/or otherwise desirable for output, wherein the set of pictures may be explicitly signaled or implicitly derived, when the corresponding coded pictures are intended to be used in association with another set of coded pictures, such as an enhancement scalable layer, in producing another set of decoded pictures; or (3) whether a certain portion of a picture is valid and/or otherwise desirable for output, when the corresponding part of a coded picture is intended to be used in association with another coded picture in producing another decoded picture. For example, both a base layer and its quality enhancement layer may comprise two slice groups, one enclosing the region-of-interest and another one for “background.” According to various invention, it can be signaled that the background of the base layer picture is good and/or otherwise desirable enough for output, while the region-of-interest requires the corresponding slice group of the enhancement layer to be present for sufficient quality. The signal element may be a part of the coded picture or access unit that it is associated with, or it may reside in a separate syntax structure from the coded picture or access unit, such as a sequence parameter set. Various embodiments of the present invention can also be used in the insertion of logos into a compressed bitstream, without having to re-encode the entire sequence.

Additionally, various embodiments of the present invention involve the use of an encoder that encode the signal element discussed above into the bitstream. The encoder can be arranged so as to operate in accordance with any of the use cases discussed previously. Furthermore, the various embodiments involve the use of a decoder that uses the signal element to conclude whether a picture, a set of pictures, or a portion of a picture is to be output.

Still further, the various embodiments of the present invention involve the use of a processing unit that takes a bitstream, including the signal element discussed herein, as an input and produces a subset of the bitstream as an output. The subset includes at least one picture that is indicated to be output according to the signal element. The operation of the processing unit can be adjusted to produce output at a certain minimum output picture rate, in which case the subset contains pictures that are indicated to be output according to the proposed signal element at least at the minimum output bitrate.

It is noted that the various embodiments of the present invention is applicable to multi-view video coding in situations where the creator of the bitstream wishes to require the display at least a certain number of views. For example, the bitstream may be solely created for stereo display, and displaying only one of the views would not suffice the artistic goal of the creator. In circumstances such as this, the output of only a single view from the decoder can be disallowed using the embodiments of the invention.

These and other advantages and features of the invention, together with the organization and manner of operation thereof, will become apparent from the following detailed description when taken in conjunction with the accompanying drawings, wherein like elements have like numerals throughout the several drawings described below.

### BRIEF DESCRIPTION OF THE DRAWINGS

FIG. 1 is an overview diagram of a system within which the present invention may be implemented;

FIG. 2 is a perspective view of a mobile device that can be used in the implementation of the present invention;

FIG. 3 is a schematic representation of the circuitry of the mobile device of FIG. 2; and

FIG. 4 is a representation of a base layer and enhancement layer including a logo.

### DETAILED DESCRIPTION OF EXEMPLARY EMBODIMENTS

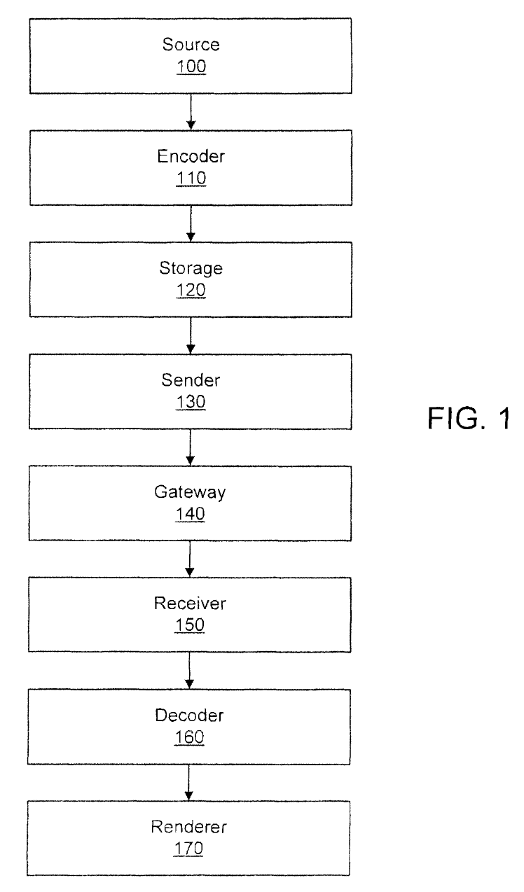

FIG. 1 shows a generic multimedia communications system. As shown in FIG. 1, a data source 100 provides a source signal in an analog, uncompressed digital, or compressed digital format, or any combination of these formats. An encoder 110 encodes the source signal into a coded media bitstream. The encoder 110 may be capable of encoding more than one media type, such as audio and video, or more than one encoder 110 may be required to code different media types of the source signal. The encoder 110 may also get synthetically produced input, such as graphics and text, or it may be capable of producing coded bitstreams of synthetic media. In the following, only processing of one coded media bitstream of one media type is considered to simplify the description. It should be noted, however, that typically real-time broadcast services comprise several streams (typically at least one audio, video and text sub-titling stream). It should also be noted that the system may include many encoders, but in the following only one encoder 110 is considered to simplify the description without a lack of generality.

The coded media bitstream is transferred to a storage 120. The storage 120 may comprise any type of mass memory to store the coded media bitstream. The format of the coded media bitstream in the storage 120 may be an elementary self-contained bitstream format, or one or more coded media bitstreams may be encapsulated into a container file. Some systems operate “live”, i.e. omit storage and transfer coded media bitstream from the encoder 110 directly to the sender 130. The coded media bitstream is then transferred to the sender 130, also referred to as the server, on a need basis. The format used in the transmission may be an elementary self-contained bitstream format, a packet stream format, or one or more coded media bitstreams may be encapsulated into a container file. The encoder 110, the storage 120, and the sender 130 may reside in the same physical device or they may be included in separate devices. The encoder 110 and sender 130 may operate with live real-time content, in which case the coded media bitstream is typically not stored permanently, but rather buffered for small periods of time in the content encoder 110 and/or in the sender 130 to smooth out variations in processing delay, transfer delay, and coded media bitrate.

The sender 130 sends the coded media bitstream using a communication protocol stack. The stack may include but is not limited to Real-Time Transport Protocol (RTP), User Datagram Protocol (UDP), and Internet Protocol (IP). When the communication protocol stack is packet-oriented, the sender 130 encapsulates the coded media bitstream into packets. For example, when RTP is used, the sender 130 encapsulates the coded media bitstream into RTP packets according to an RTP payload format. Typically, each media type has a dedicated RTP payload format. It should be again noted that a system may contain more than one sender 130, but for the sake of simplicity, the following description only considers one sender 130.

The sender 130 may or may not be connected to a gateway 140 through a communication network. The gateway 140 may perform different types of functions, such as translation of a packet stream according to one communication protocol stack to another communication protocol stack, merging and forking of data streams, and manipulation of data stream according to the downlink and/or receiver capabilities, such as controlling the bit rate of the forwarded stream according to prevailing downlink network conditions. Examples of gateways 140 include multipoint conference control units (MCUs), gateways between circuit-switched and packet-switched video telephony, Push-to-talk over Cellular (PoC) servers, IP encapsulators in digital video broadcasting-handheld (DVB-H) systems, or set-top boxes that forward broadcast transmissions locally to home wireless networks. When RTP is used, the gateway 140 is called an RTP mixer and acts as an endpoint of an RTP connection.

The system includes one or more receivers 150, typically capable of receiving, de-modulating, and de-capsulating the transmitted signal into a coded media bitstream. The coded media bitstream is typically processed further by a decoder 160, whose output is one or more uncompressed media streams. It should be noted that the bitstream to be decoded can be received from a remote device located within virtually any type of network. Additionally, the bitstream can be received from local hardware or software. Finally, a renderer 170 may reproduce the uncompressed media streams with a loudspeaker or a display, for example. The receiver 150, decoder 160, and renderer 170 may reside in the same physical device or they may be included in separate devices.

Scalability in terms of bitrate, decoding complexity, and picture size is a desirable property for heterogeneous and error prone environments. This property is desirable in order to counter limitations such as constraints on bit rate, display resolution, network throughput, and computational power in a receiving device.

It should be understood that, although text and examples contained herein may specifically describe an encoding process, one skilled in the art would readily understand that the same concepts and principles also apply to the corresponding decoding process and vice versa. It should be noted that the bitstream to be decoded can be received from a remote device located within virtually any type of network. Additionally, the bitstream can be received from local hardware or software.

Communication devices of the present invention may communicate using various transmission technologies including, but not limited to, Code Division Multiple Access (CDMA), Global System for Mobile Communications (GSM), Universal Mobile Telecommunications System (UMTS), Time Division Multiple Access (TDMA), Frequency Division Multiple Access (FDMA), Transmission Control Protocol/Internet Protocol (TCP/IP), Short Messaging Service (SMS), Multimedia Messaging Service (MMS), e-mail, Instant Messaging Service (IMS), Bluetooth, IEEE 802.11, etc. A communication device may communicate using various media including, but not limited to, radio, infrared, laser, cable connection, and the like.

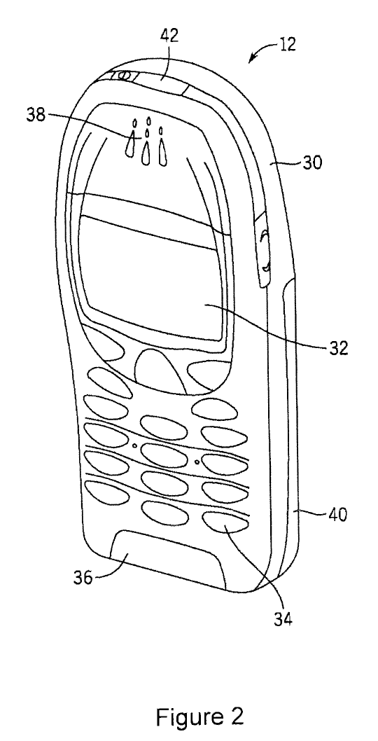

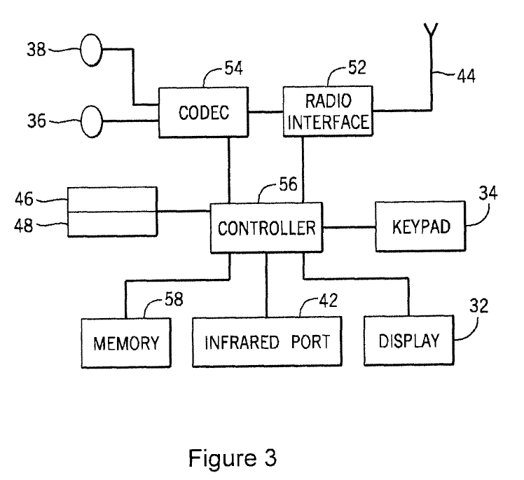

FIGS. 2 and 3 show one representative mobile device 12 within which the present invention may be implemented. It should be understood, however, that the present invention is not intended to be limited to one particular type of mobile device 12 or other electronic device. Some or all of the features depicted in FIGS. 5 and 6 could be incorporated into any or all devices that may be utilized in the system shown in FIG. 1.

The mobile device 12 of FIGS. 2 and 3 includes a housing 30, a display 32 in the form of a liquid crystal display, a keypad 34, a microphone 36, an ear-piece 38, a battery 40, an infrared port 42, an antenna 44, a smart card 46 in the form of a UICC according to one embodiment of the invention, a card reader 48, radio interface circuitry 52, codec circuitry 54, a controller 56 and a memory 58. Individual circuits and elements are all of a type well known in the art, for example in the Nokia range of mobile devices.

The present invention provides for the use of a signaling element, such as a syntax element, in a scalably coded video bitstream. In various embodiments of the present invention, a signal element, such as a syntax element in a coded video bitstream, is used to indicate (1) whether a certain decoded picture is valid and/or otherwise desirable for output when the corresponding coded picture is intended to be used in association with another coded picture in producing another decoded picture; (2) whether a certain set of pictures, such as a scalable layer, are valid and/or otherwise desirable for output, wherein the set of pictures may be explicitly signaled or implicitly derived, when the corresponding coded pictures are intended to be used in association with another set of coded pictures, such as an enhancement scalable layer, in producing another set of decoded pictures; or (3) whether a certain portion of a picture is valid and/or otherwise desirable for output, when the corresponding part of a coded picture is intended to be used in association with another coded picture in producing another decoded picture. For example, both a base layer and its quality enhancement layer may comprise two slice groups, one enclosing the region-of-interest and another one for “background.” According to various invention, it can be signaled that the background of the base layer picture is good and/or desirable enough for output, while the region-of-interest requires the corresponding slice group of the enhancement layer to be present for sufficient quality. The signal element may be a part of the coded picture or access unit that it is associated with, or it may reside in a separate syntax structure from the coded picture or access unit, such as a sequence parameter set.

According to the embodiments of the present invention, an encoder 110 of the type depicted in FIG. 1 can encode the signal element discussed above into the bitstream. The encoder 110 can be configured to operate in accordance with any of the use case scenarios discussed previously. Similarly, a decoder 160 can use the signal element to determine whether a picture, a certain set of pictures, or a certain portion of a picture is output.

Still further, and in other embodiments of the invention, a processing unit is configured to take a bitstream including the signal element as input and produce a subset of the bitstream as output. For example, the processing unit can be a sender 130, such as a streaming server, or a gateway 140, such as a RTP mixer. This subset of the bitstream includes at least one picture that is indicated to be output according to the signal element. In various embodiments, the operation of the processing unit can be adjusted to produce output at a certain maximum output bitrate, in which case the subset contains pictures that are indicated to be output according to the signal element not exceeding the maximum output bitrate.

The signal element for indicating if a certain picture is output can be included, for example, in a NAL unit header, a slice header, or a supplemental enhancement information (SEI) message associated with a picture or an access unit. A SEI message contains extra information which can be inserted into the bitstream in order to enhance the use of the video for a wide variety of purposes.

The following syntax table presents a modification to the SVC extension of NAL unit header, as specified in the draft version of the SVC standard JVT-T201 standard, with the modification reflecting the implementation of various embodiments of the present invention. Certain syntax may be removed as indicated with strikethrough.

| nal_unit_header_svc_extension( ) { | C | Descriptor |
|---|---|---|
| simple_priority_id | All | u(6) |
| discardable_flag | All | u(1) |
| [symbol] | [symbol] | [symbol] |
| output_flag | All | u(1) |
| temporal_level | All | u(3) |
| dependency_id | All | u(3) |
| quality_level | All | u(2) |
| nalUnitHeaderBytes += 2 | | |
| } | | |

The semantics of the output_flag are not specified for non-VCL NAL units. When the output_flag is equal to 0 in a VCL NAL unit, it indicates that the decoded picture corresponding to the VCL NAL unit is not to be output. When the output_flag is equal to 1 in a VCL NAL unit, it indicates that the decoded picture corresponding to the VCL NAL unit is output.

The signal element indicating if a certain group of pictures, such as the pictures of a certain scalable layer, are output can be included, for example, in a sequence parameter set or in the scalability information SEI message specified by SVC. The following syntax table presents a modification to the SVC extension of the sequence parameter set, as specified in JVT-T201, indicating which scalable layers are not output:

| seq_parameter_set_svc_extension( ) { | C | Descriptor |
|---|---|---|
| extended_spatial_scalability | 0 | u(2) |
| if ( chroma_format_idc > 0 ) { | | |
| chroma_phase_x_plus1 | 0 | u(2) |
| chroma_phase_y_plus1 | 0 | u(2) |
| } | | |
| if( extended_spatial_scalability = = 1 ) { | | |
| scaled_base_left_offset | 0 | se(v) |
| scaled_base_top_offset | 0 | se(v) |
| scaled_base_right_offset | 0 | se(v) |
| scaled_base_bottom_offset | 0 | se(v) |
| } | | |
| fgs_coding_mode | 2 | u(1) |
| if( fgs_coding_mode = = 0 ) { | | |
| groupingSizeMinus1 | 2 | ue(v) |
| } else { | | |
| numPosVector = 0 | | |
| do { | | |
| if( numPosVector = = 0 ) { | | |
| scanIndex0 | 2 | ue(v) |
| } | | |
| else { | | |
| deltaScanIndexMinus1[numPosVector] | 2 | ue(v) |
| } | | |
| numPosVector ++ | | |
| } while( scanPosVectLuma[ numPosVector − | | |
| 1 ] < 15 ) | | |
| } | | |
| num_not_output_layers | 0 | ue(v) |
| for( i = 0; i < num_not_output_layers; i++) { | | |
| dependency_id[ i ] | 0 | u(3) |
| quality_level[ i ] | 0 | u(2) |
| } | | |
| } | | |

The num_not_output_layers syntax indicates the number of scalable layers that are not output. Pictures for which the dependency_id is equal to the dependency_id[i] and the quality_level the is equal to quality_level[i] are not output.

The signal element indicating if a certain part of a certain picture is output can be included, for example, in a SEI message, a NAL unit header, or a slice header. The following SEI message indicates which slice groups of the picture should not be output or displayed. The SEI message can be enclosed in a scalable nesting SEI message (JVT-T073), which indicates the coded scalable picture within the access unit to which the SEI message relates.

| not_output_slice_group_set( payloadSize ) { | C | Descriptor |
|---|---|---|
| num_slice_groups_in_set | 5 | ue(v) |
| for( i = 0; i <= num_slice_groups_in_set; i++) | | |
| slice_group_id[ i ] | 5 | u(v) |
| } | | |

The num_slice_groups_in_set indicates the number of slice groups that should not be output, but instead replaced with the co-located decoded data in the previous picture in which the co-located decoded data is not subject to this message. The slice_group_id[i] indicates the number of the slice group that should not be output.

In the case of logo insertion, it is possible to implement various embodiments of the present invention for inserting a logo into a compressed bitstream without re-encoding the entire video sequence. An example where such an action is desirable involves a situation where a content owner, such as a film studio, provides a compressed version of the content to a service provider. The compressed version is coded for a particular bitrate and picture size that are suitable for the service. For example, the bitrate and picture size can be chosen according to the integrated receiver-decoder (IRD) classes specified in certain digital video broadcasting (DVB) specifications. Consequently, the content owner has full control of the provided video quality, as the service provider does not have to re-encode the content for the service. However, it may be desirable for the service provider to add its logo into the stream.

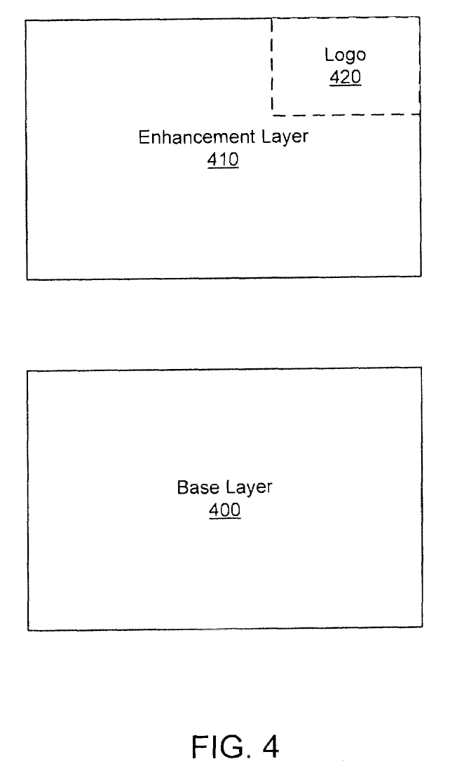

One system and method for addressing the above issue is depicted in FIG. 4 and is generally as follows. As shown in FIG. 4, a base layer 400 (i.e., a first coded picture) of the bitstream is unchanged. An enhancement layer 410 (i.e., a second coded picture) is coded such that the area covered by the logo 420 is coded as one or more slices. The spatial resolution of the enhancement layer may be different from the spatial resolution of the base layer. If more than one slice group is allowed in the profile in use, then it is possible to cover the logo 420 in one slice group and therefore also in one slice. The logo 420 is then blended over the decoded or uncompressed area, and the slices covering the logo are re-encoded for the enhancement layer 410. The “skip slice” flag in the slice headers of the remaining slices in the enhancement layer is set to 1. This “skip slice” flag being equal to 1 for a slice indicates that no further information than the slice header is sent for the slice, in which case all of the macroblocks are reconstructed using information of collocated macroblocks in the base layer used for inter-layer prediction. In order to make ripping of the logo-free version of the content illegal, decoders must not output the base layer decoded pictures, even if the enhancement layer 410 was not present. This particular use can be implemented by setting the output_flag in all NAL units of the base layer 400 to 0. The layer_output_flag[i] in the scalability information SEI message is set to 0 for the base layer 400.

The present invention is described in the general context of method steps, which may be implemented in one embodiment by a program product including computer-executable instructions, such as program code, executed by computers in networked environments. Generally, program modules include routines, programs, objects, components, data structures, etc. that perform particular tasks or implement particular abstract data types. Computer-executable instructions, associated data structures, and program modules represent examples of program code for executing steps of the methods disclosed herein. The particular sequence of such executable instructions or associated data structures represents examples of corresponding acts for implementing the functions described in such steps.

Software and web implementations of the present invention could be accomplished with standard programming techniques with rule based logic and other logic to accomplish the various database searching steps, correlation steps, comparison steps and decision steps. It should also be noted that the words “component” and “module,” as used herein and in the claims, is intended to encompass implementations using one or more lines of software code, and/or hardware implementations, and/or equipment for receiving manual inputs.

The foregoing description of embodiments of the present invention have been presented for purposes of illustration and description. It is not intended to be exhaustive or to limit the present invention to the precise form disclosed, and modifications and variations are possible in light of the above teachings or may be acquired from practice of the present invention. The embodiments were chosen and described in order to explain the principles of the present invention and its practical application to enable one skilled in the art to utilize the present invention in various embodiments and with various modifications as are suited to the particular use contemplated.

What is claimed is:

1. A method of encoding video content, comprising:
encoding a plurality of pictures into an encoded bitstream; and
providing information in the encoded bitstream, the information associated with at least a portion of the encoded plurality of pictures and being indicative of a desired output property.

2. The method of claim 1, wherein the information comprises an indicator indicative of whether one of an entire picture and a portion of a corresponding picture is to be output.

3. The method of claim 1, wherein the information comprises at least one identifier element, the at least one identifier element indicating one of a set of pictures and a set of picture portions that are not to be output.

4. The method of claim 1, wherein one of the plurality of encoded pictures is a background picture, and wherein the information indicates that the background picture is not to be output.

5. The method of claim 1, wherein the information indicates that a virtual reference picture is not to be output.

6. The method of claim 1, wherein one of the plurality of encoded pictures comprises a coded logo.

7. The method of claim 6, wherein the one of the plurality of encoded pictures belongs to an enhancement layer of a scalable coded video bitstream.

8. The method of claim 1, wherein one of the plurality of encoded pictures belongs to one of a base layer and an enhancement layer of a scalable coded video bitstream.

9. The method of claim 1, wherein the information is encoded in a network abstraction layer unit header.

10. The method of claim 1, wherein the information is encoded in a slice header.

11. The method of claim 1, wherein the information is encoded in a supplemental enhancement information message.

12. The method of claim 11, wherein the supplemental enhancement information message is associated with one of the plurality of pictures.

13. The method of claim 11, wherein the supplemental enhancement information message is associated with an access unit, the access unit comprising the plurality of pictures.

14. A computer program product, embodied in a computer-readable medium, for encoding video content, comprising computer code configured to perform the processes of claim 1.

15. An encoding apparatus, comprising:
a processor; and
a memory unit communicatively associated with the processor and including:
computer code for encoding a plurality of pictures into an encoded bitstream; and
computer code for providing information in the encoded bitstream, the information associated with at least a portion of the encoded plurality of pictures and being indicative of a desired output property.

16. The apparatus of claim 15, wherein the information comprises an indicator indicative of whether one of an entire picture and a portion of a corresponding picture is to be output.

17. The apparatus of claim 15, wherein the information comprises at least one identifier element, the at least one identifier element indicating one of a set of pictures and a set of picture portions that are not to be output.

18. The apparatus of claim 15, wherein one of the plurality of encoded pictures is a background picture, and wherein the information indicates that the background picture is not to be output.

19. The apparatus of claim 15, wherein the information indicates that a virtual reference picture is not to be output.

20. The apparatus of claim 15, wherein one of the plurality of encoded pictures comprises a coded logo.

21. The apparatus of claim 15, wherein one of the plurality of encoded pictures belongs to one of a base layer and an enhancement layer of a scalable coded video bitstream.

22. The apparatus of claim 15, wherein the information is encoded in a network abstraction layer unit header.

23. The apparatus of claim 15, wherein the information is encoded in a slice header.

24. The apparatus of claim 15, wherein the information is encoded in a supplemental enhancement information message.

25. The apparatus of claim 24, wherein the supplemental enhancement information message is associated with one of the plurality of pictures.

26. The apparatus of claim 24, wherein the supplemental enhancement information message is associated with an access unit, the access unit comprising the plurality of pictures.

27. A method of selectively outputting a plurality of pictures, comprising:
decoding the plurality of pictures from an encoded bitstream;
decoding information from the bitstream, the information associated with at least a portion of the decoded plurality of pictures and being indicative of a desired output property; and
selectively outputting the plurality of pictures based upon the information.

28. The method of claim 27, wherein the information comprises an indicator indicative of whether one of an entire picture and a portion of a corresponding picture is to be output.

29. The method of claim 27, wherein the information comprises at least one identifier element, the at least one identifier element indicating one of a set of pictures and a set of picture portions that are not to be output.

30. The method of claim 27, wherein one of the plurality of pictures is a background picture, and wherein the information indicates that the background picture is not to be output.

31. The method of claim 27, wherein the information indicates that a virtual reference picture is not to be output.

32. The method of claim 27, wherein one of the plurality of pictures comprises a coded logo.

33. The method of claim 32, wherein the one of the plurality of pictures belongs to an enhancement layer of a scalable coded video bitstream.

34. The method of claim 27, wherein one of the plurality of pictures belongs to one of a base layer and an enhancement layer of a scalable coded video bitstream.

35. The method of claim 27, wherein the information is decoded from a network abstraction layer unit header.

36. The method of claim 27, wherein the information is decoded from a slice header.

37. The method of claim 27, wherein the information is decoded from a supplemental enhancement information message.

38. The method of claim 37, wherein the supplemental enhancement information message is associated with one of the plurality of pictures.

39. The method of claim 37, wherein the supplemental enhancement information message is associated with an access unit, the access unit comprising the plurality of pictures.

40. A computer program product, embodied in a computer-readable medium, comprising computer code configured to perform the processes of claim 29.

41. A decoding apparatus, comprising:
a processor; and
a memory unit communicatively connected to the processor and including:
computer code for decoding the plurality of pictures from an encoded bitstream;
computer code for decoding information from the bitstream, the information associated with at least a portion of the decoded plurality of pictures and being indicative of a desired output property; and
selectively outputting the plurality of pictures based upon the information.

42. The apparatus of claim 41, wherein the information comprises an indicator indicative of whether one of an entire picture and a portion of a corresponding picture is to be output.

43. The apparatus of claim 41, wherein the information comprises at least one identifier element, the at least one identifier element indicating one of a set of pictures and a set of picture portions that are not to be output.

44. The apparatus of claim 41, wherein one of the plurality of pictures is a background picture, and wherein the information indicates that the background picture is not to be output.

45. The apparatus of claim 41, wherein the information indicates that a virtual reference picture is not to be output.

46. The apparatus of claim 41, wherein one of the plurality of pictures comprises a coded logo.

47. The apparatus of claim 41, wherein one of the plurality of pictures belongs to one of a base layer and an enhancement layer of a scalable coded video bitstream.

48. The apparatus of claim 41, wherein the information is decoded from a network abstraction layer unit header.

49. The apparatus of claim 41, wherein the information is decoded from a slice header.

50. The apparatus of claim 41, wherein the information is decoded from a supplemental enhancement information message.

51. The apparatus of claim 50, wherein the supplemental enhancement information message is associated with one of the plurality of pictures.

52. The method of claim 50, wherein the supplemental enhancement information message is associated with an access unit, the access unit comprising the plurality of pictures.

53. A processing unit, comprising:
computer code for processing information from a bitstream, the information indicating whether at least a portion of a first decoded picture is to be output, wherein the decoding of a first coded picture results in the first decoded picture and the decoding of the first coded picture and a second coded picture results in a second decoded picture; and
computer code for selectively outputting the first decoded picture based upon the indication of the information.

54. An apparatus, comprising:
a processor; and
a memory unit communicatively connected to the processor,
wherein the apparatus is configured to:
receive a first coded picture, a second coded picture and information indicating whether at least a portion of a first decoded picture is to be output, wherein the decoding of the first coded picture results in the first decoded picture and the decoding of the first coded picture and the second coded picture results in a second decoded picture; and
selectively transmit the second coded picture based upon the indication of the decoded information.
